(19) United States
(12) Patent Application Publication
(10) Pub. No.: US 2012/0300280 A1
(43) Pub. Date: Nov. 29, 2012

(54) BRIDGED BUS BAR FOR ELECTROCHROMIC DEVICES

(75) Inventors: Sean Murphy, Burnsville, MN (US); Neil L. Sbar, Northfield, MN (US); Greg McComiskey, Faribault, MN (US)

(73) Assignee: SAGE ELECTROCHROMICS, INC., Faribault, MN (US)

(21) Appl. No.: 13/479,781

(22) Filed: May 24, 2012

Related U.S. Application Data
(60) Provisional application No. 61/490,291, filed on May 26, 2011.

(51) Int. Cl. G02F 1/161; B05D 5/00

(52) U.S. Cl. 359/275; 359/265; 427/58

(57) ABSTRACT

In one aspect of the present invention is an electrochromic device comprising at least one bus bar, wherein the at least one bus bar is in communication with a conductive seal. In some embodiments of the present invention, the conductive seal is comprised of a material selected from the group consisting of an adhesive, resin, or polymer impregnated with a suitable conductive metal or an intrinsically conductive polymer.

### CROSS REFERENCED TO RELATED APPLICATIONS

This application claims the benefit of the filing date of U.S. provisional Patent Application No. 61/490,291 filed May 26, 2011, the disclosure of which is hereby incorporated herein by reference.

### FIELD OF THE INVENTION

This invention relates to electrochromic devices which can vary the transmission or reflectance of electromagnetic radiation by application of an electrical potential to the electrochromic device.

### BACKGROUND OF THE INVENTION

Electrochromic glazings include electrochromic materials that are known to change their optical properties, such as coloration, in response to the application of an electrical potential, thereby making the device more or less transparent or more or less reflective. Typical prior art electrochromic devices (hereinafter “EC devices”) include a counter electrode layer, an electrochromic material layer which is deposited substantially parallel to the counter electrode layer, and an ionically conductive layer separating the counter electrode layer from the electrochromic layer respectively. In addition, two transparent conductive layers are substantially parallel to and in contact with the counter electrode layer and the electrochromic layer. Materials for making the counter electrode layer, the electrochromic material layer, the ionically conductive layer and the conductive layers are known and described, for example, in United States Patent Publication No. 2008/0169185, incorporated by reference herein, and desirably are substantially transparent oxides or nitrides.

Traditional EC devices and the insulated glass units (hereinafter “IGUs”) comprising them have the structure shown in FIG. 1. As used herein, the term “insulated glass unit” means two or more layers of glass separated by a spacer 1 (metal, plastic, foam, resin based) along the edge and sealed (seal not depicted) to create a dead air space, “insulated space” (or other gas, e.g. argon, nitrogen, krypton) between the layers. The IGU 2 comprises an interior glass panel 3 and an EC device 4, described further herein.

FIGS. 2 and 3 illustrate plan and cross-sectional views, respectively, of a typical prior art electrochromic device 20. The device 20 includes isolated transparent conductive layer regions 26A and 26B that have been formed on a substrate 34. The EC device 20 includes a counter electrode layer 28, an ion conductive layer 32, an electrochromic layer 30 and a transparent conductive layer 24, which have been deposited in sequence over the conductive layer regions 26. Further, the device 20 includes a bus bar 40 which is in contact only with the conductive layer region 26A, and a bus bar 42 which may be formed on the conductive layer region 26B and is in contact with the conductive layer 24. The conductive layer region 26A is physically isolated from the conductive layer region 26B and the bus bar 42, and the conductive layer 24 is physically isolated from the bus bar 40. Further, the bus bars 40 and 42 are connected by wires to positive and negative terminals, respectively, of a low voltage electrical source 22.

Referring to FIGS. 2 and 3, when the source 22 is operated to apply an electrical potential across the bus bars 40, 42, electrons, and thus a current, flows from the bus bar 42, across the transparent conductive layer 24 and into the electrochromic layer 30. Further, ions, such as Li+ stored in the counter electrode layer, flow from the counter electrode layer 28, through the ion conductive layer 32, and to the electrochromic layer 30, and a charge balance is maintained by electrons being extracted from the counter electrode layer 28, and then being inserted into the electrochromic layer 30 via the external circuit. The transfer of ions and electrons to the electrochromic layer causes the optical characteristics of the electrochromic layer, and optionally the counter electrode layer in a complementary EC device, to change, thereby changing the coloration and, thus, the transparency of the EC device. It is desirable to position the bus bars near the sides of the device 20, where the bus bars, which typically have a width of not more than about 0.25 inches, are not visible or are minimally visible, such that the device is aesthetically pleasing when installed in a typical window frame.

It is necessary for the bus bar material to extend beyond the IGU seal such that an electrical connection can be made outside the IGU. An internal connection to the transparent conductor layer would, it is believed, compromise the aesthetics of the EC device. Moreover, the typical low temperature bus bar materials employed in the art, e.g. silver-based thick film frit materials, are porous. As a result, the there is believed to be a leakage of the inert gas stored in the dead air space of the IGU when traditional frit materials are extended outside the IGU under the spacer.

### BRIEF SUMMARY OF THE INVENTION

In one aspect of the present invention is an electrochromic device comprising at least one bus bar, wherein the at least one bus bar is in communication with a conductive seal. In some embodiments of the present invention, the conductive seal is comprised of a material selected from the group consisting of an adhesive, resin, or polymer impregnated with a suitable conductive metal or an intrinsically conductive polymer.

In some embodiments of the present invention, the conductive seal at least partially contacts a continuous bus bar. In other embodiments of the present invention, the conductive seal forms a bridge connecting two segments of a bus bar. In yet other embodiments of the present invention, the conductive seal covers at least a portion of the bus bar. In some embodiments of the present invention, the conductive seal overlaps at least a portion of the bus bar in at least one dimension. In some embodiments, the conductive seal material at least partially penetrates pores in the bus bar(s).

In another aspect of the present invention is a system comprising an electrochromic device having at least one bus bar and a conductive seal in communication with the at least one bus bar, wherein the conductive seal is less porous than the bus bar and has an electrical resistance of between about 0.1 ohm/ft to about 0.6 ohm/ft. In some embodiments, the conductive seal has a cure temperature of less than about 420° C. In some embodiments, the conductive seal and the bus bar are cured contemporaneously.

In some embodiments, the conductive seal is comprised of a conductive epoxy selected from the group consisting of silver epoxies, nickel epoxies, chromium epoxies, gold epoxies, tungsten epoxies, alloy epoxies, and mixtures thereof. In some embodiments, the conductive seal comprises a silver epoxy. In some embodiments, the conductive seal is comprised of an intrinsically conductive polymer.

In some embodiments, the conductive seal mitigates the loss of a gas through the bus bar. In some embodiments, the conductive seal retains or allows retention of at least 80% of the gas over at least about 30 days which would otherwise be lost through, for example, pores in the bus bars. In some embodiments, the conductive seal retains at least about 80% of the gas over at least about 45 days. In some embodiments, the conductive seal retains at least about 80% of the gas over at least about 60 days.

In some embodiments, the conductive seal retains at least about 90% of the gas over at least about 30 days. In some embodiments, the conductive seal retains at least about 90% of the gas over at least about 45 days. In some embodiments, the conductive seal retains at least about 90% of the gas over at least about 60 days.

In some embodiments, the conductive seal retains at least about 95% of the gas over at least about 30 days. In some embodiments, the conductive seal retains at least 95% of the gas over at least about 45 days. In some embodiments, the conductive seal retains at least about 95% of the gas over at least about 60 days.

In some embodiments, the conductive seal at least partially overlaps the bus bar in at least one dimension. In some embodiments, the conductive seal at least partially overlaps the bus bar in at least two dimensions. In some embodiments, the conductive seal has a thickness ranging from about 20 μm to about 50 μm.

In some embodiments, if more than one bus bar is present, each bus bar may be covered by a different conductive seal. In other embodiments, if more than one bus bar is present, one bus bar may be covered with a conductive seal while the other is covered with a non-conductive seal.

In another aspect of the present invention is an insulated glass unit comprising an electrochromic device having at least two bus bars and a glass panel, wherein the electrochromic device and the glass panel are arranged substantially parallel to each other and are connected by a spacer to form an insulated space, and wherein a seal is sandwiched between the spacer and the electrochromic device and the seal is in communication with at least a portion of the at least two bus bars. In some embodiments, an insulator, such as polyisobutylene, is between the spacer and the seal.

The seal may be placed over the bus bar directly. In some embodiments, the seal is a non-conductive seal. In other embodiments, the seal is a conductive seal. In other embodiments, the non-conductive seal is fixed to a portion of the spacer.

In some embodiments, the seal at least partially penetrates pores in the bus bar. In some embodiments, the non-conductive seal at least partially penetrates pores in the bus bar. In some embodiments, the conductive seal at least partially penetrates pores in the bus bar.

In some embodiments, a non-conductive seal may be used to prevent shorts (for example, shorts that may occur between a spacer made of a conductive material and a bus bar). In some embodiments, the non-conductive seal is an epoxy, a polymer, a resin, or an adhesive. In some embodiments, the non-conductive seal is an epoxy, wherein the epoxy is less porous than the at least two bus bars. In some embodiments, a non-conductive seal is chosen (based on material parameters or processing parameters) such that the material may at least partially penetrate pores in a bus bar.

In some embodiments, the bus bar is covered with an ink, the ink being one of a thick film material, and which acts as an insulator (e.g. to assist in short prevention). In some embodiments, the ink is itself essentially non-porous. In some embodiments, the ink is a black colored ink.

In some embodiments, the least one of the at least two bus bars are continuous. In some embodiments, the seal covers the continuous bus bar. The seal may be in contact with the spacer or with an insulator (polyisobutylene) which is adjacent to the spacer.

In some embodiments, the at least one of the at least two bus bars are segmented. In some embodiments, the segmented bus bar comprises an interior portion and an exterior portion. In some embodiments, the conductive seal is in communication with at least a portion of each of the interior and exterior bus bar portions. The seal, in some embodiments, resides in an area under the spacer.

In some embodiments, the conductive seal is in communication with at least one of the at least two bus bars and an electrical voltage source. The seal, in some embodiments, resides in an area under the spacer.

In another aspect of the present invention is an insulated glass unit comprising an electrochromic device having at least two bus bars on a top surface of the electrochromic device and a glass panel, wherein the electrochromic device top surface and the glass panel are arranged substantially parallel to each other and are connected by a spacer to form an insulated space, wherein each of the bus bars have interior and exterior bus bar portions, the interior bus bar portions are positioned within the insulated space and the exterior bus bar portions are positioned outside the insulated space, and wherein a conductive seal is in communication with the interior and exterior bus bar portions.

In some embodiments, the conductive seal is positioned between the spacer and the electrochromic device top surface. In some embodiments, the conductive seal bridges the interior and exterior bus bar portions and provides electrical communication between the interior and exterior bus bar portions. In some embodiments, the conductive seal is in-line with the interior and exterior bus bar portions. In some embodiments, the conductive seal at least partially overlaps with at least one of the interior or exterior bus bar portions.

In some embodiments, the conductive seal is less porous than the at least two bus bars and has an electrical resistance of between about 0.1 ohm/ft to about 0.6 ohm/ft.

In some embodiments, the conductive seal is selected from the group consisting of an adhesive impregnated with a suitable conductive metal, a resin impregnated with a suitable conductive metal, a polymer impregnated with a suitable conductive metal, and an intrinsically conductive polymer. In some embodiments, the conductive seal is a conductive epoxy. In some embodiments, the conductive epoxy is selected from the group consisting of silver epoxies, nickel epoxies, chromium epoxies, gold epoxies, tungsten epoxies, alloy epoxies, and mixtures thereof. In some embodiments, the conductive seal comprises a silver epoxy. In some embodiments, the conductive seal is comprised of an intrinsically conductive polymer.

In some embodiments, the conductive seal retains at least about 90% of the gas over at least about 30 days. In some embodiments, the conductive seal retains at least about 90% of the gas over at least about 45 days. In some embodiments, the conductive seal retains at least about 90% of the gas over at least about 60 days.

In some embodiments, the conductive seal retains at least about 95% of the gas over at least about 30 days. In some embodiments, the conductive seal retains at least about 95% of the gas over at least about 45 days. In some embodiments, the conductive seal retains at least about 95% of the gas over at least about 60 days.

In another aspect of the present invention is an insulated glass unit comprising an electrochromic device having at least two bus bars on a top surface of the electrochromic device and a glass panel, wherein the electrochromic device top surface and the glass panel are arranged substantially parallel to each other and are connected by a spacer to form an insulated space, wherein each of the bus bars are continuous, whereby at least a portion of the at least two bus bars are positioned between the electrochromic device top surface and the spacer to form bus bar contact points, and wherein a conductive seal covers at least a portion of the bus bar contact points.

In some embodiments, the conductive seal is less porous than the at least two bus bars and has an electrical resistance of between about 0.1 ohm/ft to about 0.6 ohm/ft.

In some embodiments, the conductive seal is selected from the group consisting of an adhesive impregnated with a suitable conductive metal, a resin impregnated with a suitable conductive metal, a polymer impregnated with a suitable conductive metal, and an intrinsically conductive polymer. In some embodiments, the conductive seal is a conductive epoxy. In some embodiments, the conductive epoxy are selected from the group consisting of silver epoxies, nickel epoxies, chromium epoxies, gold epoxies, tungsten epoxies, alloy epoxies, and mixtures thereof. In some embodiments, the conductive seal comprises a silver epoxy.

In some embodiments, the conductive seal retains at least about 90% of the gas over at least about 30 days. In some embodiments, the conductive seal retains at least about 90% of the gas over at least about 45 days. In some embodiments, the conductive seal retains at least about 90% of the gas over at least about 60 days.

In some embodiments, the conductive seal retains at least about 95% of the gas over at least about 30 days. In some embodiments, the conductive seal retains at least about 95% of the gas over at least about 45 days. In some embodiments, the conductive seal retains at least about 95% of the gas over at least about 60 days.

In another aspect of the present invention is an insulated glass unit comprising an electrochromic device having at least two bus bars on a top surface of the electrochromic device and a glass panel, wherein the electrochromic device top surface and the glass panel are arranged substantially parallel to each other and are connected by a spacer to form an insulated space, wherein each of the bus bars are located substantially within the insulated space, and wherein a conductive seal is communication with at least a portion of the bus bars and an external voltage source.

In some embodiments, the conductive seal is less porous than the at least two bus bars and has an electrical resistance of between about 0.1 ohm/ft to about 0.6 ohm/ft.

In some embodiments, the conductive seal is selected from the group consisting of an adhesive impregnated with a suitable conductive metal, a resin impregnated with a suitable conductive metal, a polymer impregnated with a suitable conductive metal, and an intrinsically conductive polymer. In some embodiments, the conductive seal is a conductive epoxy. In some embodiments, the conductive epoxy are selected from the group consisting of silver epoxies, nickel epoxies, chromium epoxies, gold epoxies, tungsten epoxies, alloy epoxies, and mixtures thereof. In some embodiments, the conductive seal comprises a silver epoxy.

In some embodiments, the conductive seal retains at least about 90% of the gas over at least about 30 days. In some embodiments, the conductive seal retains at least about 90% of the gas over at least about 45 days. In some embodiments, the conductive seal retains at least about 90% of the gas over at least about 60 days.

In some embodiments, the conductive seal retains at least about 95% of the gas over at least about 30 days. In some embodiments, the conductive seal retains at least about 95% of the gas over at least about 45 days. In some embodiments, the conductive seal retains at least about 95% of the gas over at least about 60 days.

In another aspect of the present invention is an insulated glass unit comprising (i) an EC device having at least two bus bars on an EC device top surface, (ii) a glass panel, and (iii) a spacer positioned along a periphery of the EC device top surface, connecting the EC device to the glass panel to form an interior insulated glass unit space, wherein each of the two bus bars have interior and exterior bus bar portions, the interior bus bar portion of each bus bar positioned within the interior insulated glass unit space and the exterior bus bar portion of each bus bar positioned outside the interior insulated glass unit space, and wherein a conductive seal is in electrical communication with the interior and exterior bus bar portions of each bus bar, the conductive seal is positioned between the spacer (but not necessarily in contact with the spacer) and the EC device top surface and in-line with the interior and exterior bus bar portions of each bus bar. In some embodiments of the present invention, the conductive seal is comprised of a material selected from the group consisting of an adhesive, resin, or polymer (each impregnated with a suitable conductive metal) or an intrinsically conductive polymer.

In some embodiments, at least one of the two bus bars are continuous such that at least a portion of the bus bar runs under the spacer. In some embodiments, the conductive seal is positioned over and/or covers each dimension of the bus bar portion that runs under the spacer.

In some embodiments, at least one of the two bus bars are segmented such that no bus bar runs under the spacer. In some embodiments, the conductive seal connects the interior and exterior bus bar portions with the conductive seal positioned under the spacer. In some embodiments, the conductive seal partially overlaps the interior and exterior bus bar in at least one dimension. In some embodiments, the overlap ranges from about 1 mm to about 5 mm.

In yet another aspect of the present invention is an insulated glass unit comprising (i) an EC device having at least two bus bars on an EC device top surface, (ii) a glass panel, and (iii) a spacer positioned along a periphery of the EC device top surface, connecting the EC device to the glass panel to form an interior insulated glass unit space, wherein each of the at least two bus bars are positioned within the interior insulated glass unit space, each terminating between about 0.1 cm to about 1 cm from interior edges of the spacer, and wherein a conductive seal is in electrical communication with each bus bar, the conductive seal contacting termination points of the bus bar and extending under the spacer to an exterior edge of the EC device top surface. In some embodiments of the present invention, the conductive seal is comprised of a material selected from the group consisting of an adhesive, resin, or polymer (each impregnated with a suitable conductive metal) or an intrinsically conductive polymer. In some embodiments, the conductive seal is in electrical communication with an outside voltage source.

In another aspect of the present invention is an insulated glass unit comprising (1) an EC device having at least one bus bar, (2) a glass panel, (3) a spacer positioned along the periphery of the EC device and connected to the glass panel to form an interior insulated glass unit space, and (4) a conductive seal sandwiched between the spacer (but not necessarily in contact with the spacer) and the EC device and in communication with at least a portion of the at least one bus bar.

In another aspect of the present invention is a method of mitigating a loss of a gas (or mixture of gases) from an insulated space in an insulated glass unit comprising covering or coating a portion of a bus bar that passes under a spacer in the insulated glass unit with a seal. In some embodiments, the seal is a conductive seal. In some embodiments, the conductive seal is a conductive epoxy. In some embodiments, the conductive epoxy is selected from the group consisting of silver epoxies, nickel epoxies, chromium epoxies, gold epoxies, tungsten epoxies, alloy epoxies, and mixtures thereof. In some embodiments, the conductive seal comprises a silver epoxy. In some embodiments, the conductive seal retains at least about 90% of the gas over at least about 30 days. In some embodiments, the conductive seal retains at least about 90% of the gas over at least about 45 days. In some embodiments, the conductive seal retains at least about 90% of the gas over at least about 60 days. In some embodiments, the conductive seal retains at least about 95% of the gas over at least about 30 days. In some embodiments, the conductive seal retains at least about 95% of the gas over at least about 45 days. In some embodiments, the conductive seal retains at least about 95% of the gas over at least about 60 days.

In yet another aspect of the present invention is a method of mitigating the loss of an inert atmosphere from an IGU interior space comprising bridging, replacing, or covering a portion of the bus bar that passes under a spacer with a conductive seal.

In another aspect of the present invention is a method of mitigating the loss of an inert atmosphere from an IGU interior space comprising bridging, replacing, or covering a portion of the bus bar that passes under a spacer with an effective amount of a conductive seal material.

In yet another aspect of the present invention is a method of manufacturing an insulated glass unit comprising a seal running beneath, or attached to, a spacer. The seal may be conductive or non-conductive.

### BRIEF DESCRIPTION OF THE DRAWINGS

FIG. 1 is a cross-sectional view of an IGU comprising an EC device.

FIG. 2 is a plan view of a traditional EC device.

FIG. 3 is a cross-sectional view of a traditional EC device.

FIG. 4A is a cross-sectional view of an IGU comprising a bus bar bridged by a conductive seal.

FIG. 4B is a plan view of an IGU comprising a bus bar bridged by a conductive seal.

FIG. 4C is a plan view of a termination point of a bus bar, illustrating overlap with a conductive seal.

FIG. 5 is a cross-sectional view of an IGU comprising a bus bar partially covered by a conductive seal.

FIG. 6 is a cross-sectional view of an IGU comprising an interior bus bar in communication with a conductive seal running to the edge of the EC device.

FIG. 7A illustrates the amount of gas leakage over time from traditional IGUs.

FIG. 7B illustrates the amount of gas leakage over time from traditional IGUs.

FIG. 8A illustrates the amount of gas leakage over time from experimental IGUs having a conductive seal.

FIG. 8B illustrates the amount of gas leakage over time from experimental IGUs having a conductive seal.

FIG. 9A is a cross-sectional view of an IGU comprising a bus bar partially covered by a conductive seal.

FIG. 9B is a cross-sectional view of an IGU comprising a bus bar partially covered by a conductive seal.

FIG. 10 illustrates the amount of gas leakage over time from experimental IGUs having a conductive seal.

FIG. 11 illustrates the amount of gas leakage over time from experimental IGUs having a conductive seal.

FIG. 12 illustrates the amount of gas leakage over time from experimental IGUs having a conductive seal.

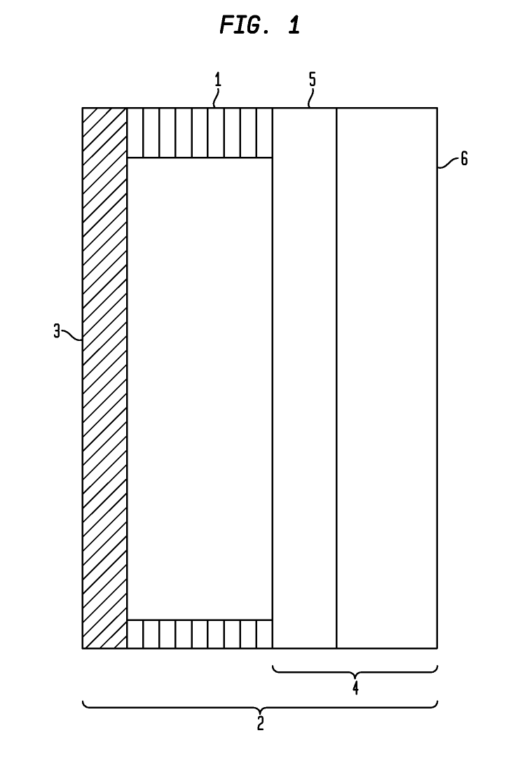

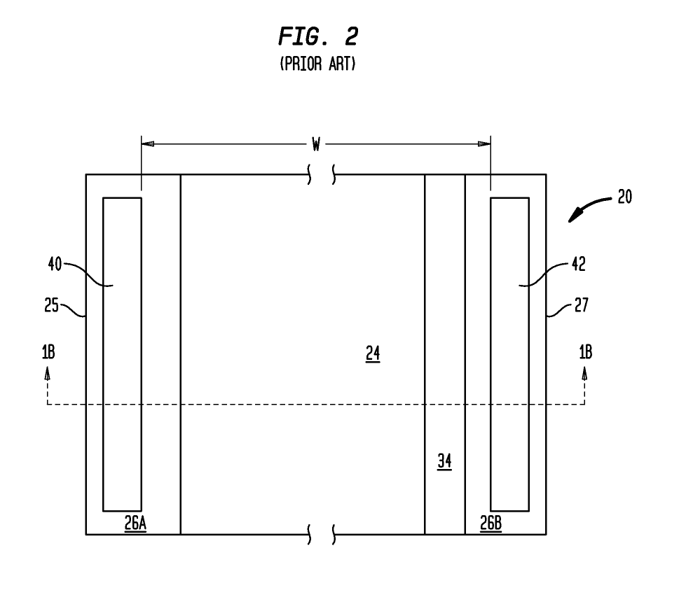

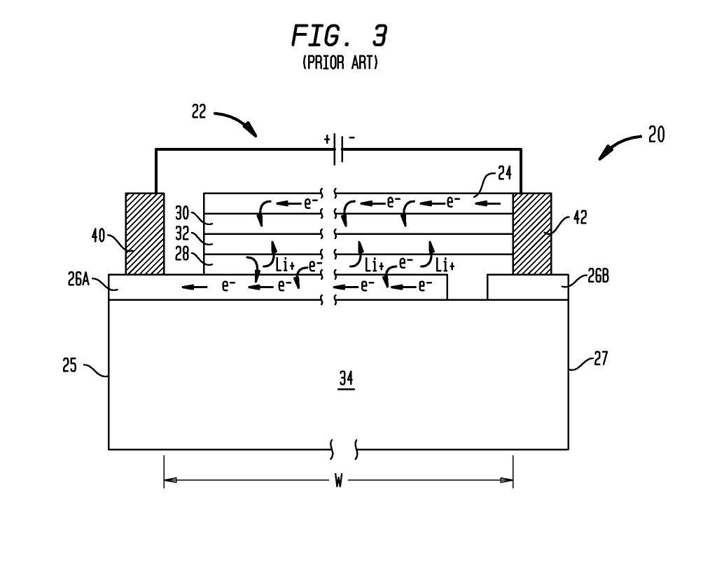

### DETAILED DESCRIPTION

In one aspect of the present invention is a substrate having a bus bar bridged by, covered by, connected to or penetrated by a conductive seal or a non-conductive seal. In another aspect of the present invention is an EC device having a bus bar bridged by, covered by, or connected to a conductive seal. In another aspect of the present invention is an IGU having an EC device comprising a bus bar bridged by, covered by, or connected to a conductive seal.

In addition to covering or coating a bus bar, the seals described herein may penetrate at least some pores in a bus bar.

As used herein, the term “substrate” refers to glass, plastic, metal, a thin film material, or an EC device. While specific examples may demonstrate a bus bar and seal applied to an EC device, the technology disclosed herein is directly applicable to other devices, such as batteries and TFT-displays.

As used herein, the term “mitigate” has its common meaning, i.e. to lessen. In some embodiments, mitigating the loss of a gas from an insulated space means that at least about 35% of the gas is retained that would otherwise be lost or escape through, it is believed, pores in the bus bars. In some embodiments, mitigating the loss of a gas from an insulated space means that at least about 45% of the gas is retained. In some embodiments, mitigating the loss of a gas from an insulated space means that at least about 50% of the gas is retained. In some embodiments, mitigating the loss of a gas from an insulated space means that at least about 60% of the gas is retained. In some embodiments, mitigating the loss of a gas from an insulated space means that at least about 75% of the gas is retained.

As used herein, the term “substantially parallel” means that two objects are either parallel to each other or positioned relative to each other such that the two objects would or could intersect. As such, the term may refer to positioning the objects at any angle, provided they are not positioned at a 90° angle relative to each other. For example, two substrates may be set at 30°, 45°, or 60° angles relative to each other.

It should be understood that a seal may or may not directly contact a spacer (e.g. a spacer made of conductive material could short to conductive seal which is in contact with a bus bar). As such, it should be understood that the term “contact”, “contacting a spacer”, or like terms does not mean that the seal directly contacts the spacer. It can be that the seal and/or bus bar are positioned under a spacer, but not directly in contact with the spacer. In some embodiments, a polyisobutylene, or other insulator, may be used to prevent such shorts when positioned between such a spacer and seal.

Devices

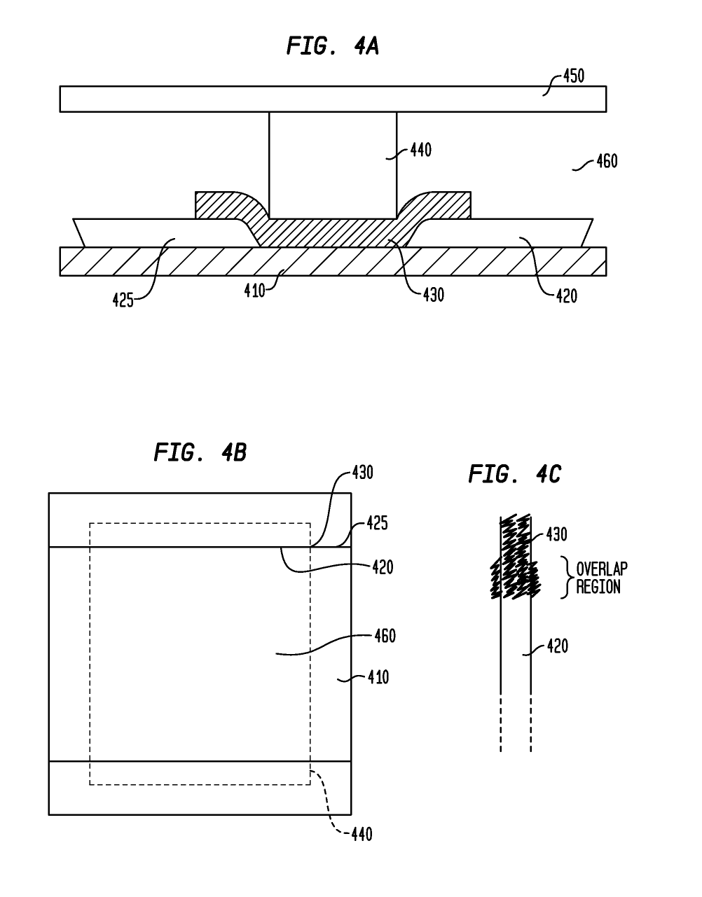

In some embodiments, a conductive seal bridges or connects a segmented bus bar or an interior bus bar and an exterior bus bar, as illustrated in the plan and cross-section views of FIGS. 4A and 4B. The bus bar found in a traditional EC device is separated into two regions or segments, namely an interior bus bar 420 and an exterior bus bar 425. The bus bars 420 and 425 are bridged by a conductive seal 430. A spacer 440 connects and seals the EC device 410 to another glass panel 450 to form an IGU having an interior space 460. The conductive seal 430 is positioned beneath the spacer 440 and, it is believed, serves to conduct voltage and/or current between the bus bar segments while preventing, mitigating, or slowing (hereinafter “preventing”) the escape of inert gas from the interior space 460. When a conductive spacer is used, a polyisobutylene, or other insulator, could be applied between such a spacer and the seal. As shown in FIG. 4B, the spacer 440 is placed along the periphery of the EC device 410, as known in the art, whereby an interior space 460, formed by the placement of the spacer, contains a gas, preferably an inert gas. In some embodiments, the internal and external bus bars are positioned, independently, from about 0.1 cm to about 1.0 cm from the edges of spacer, respectively.

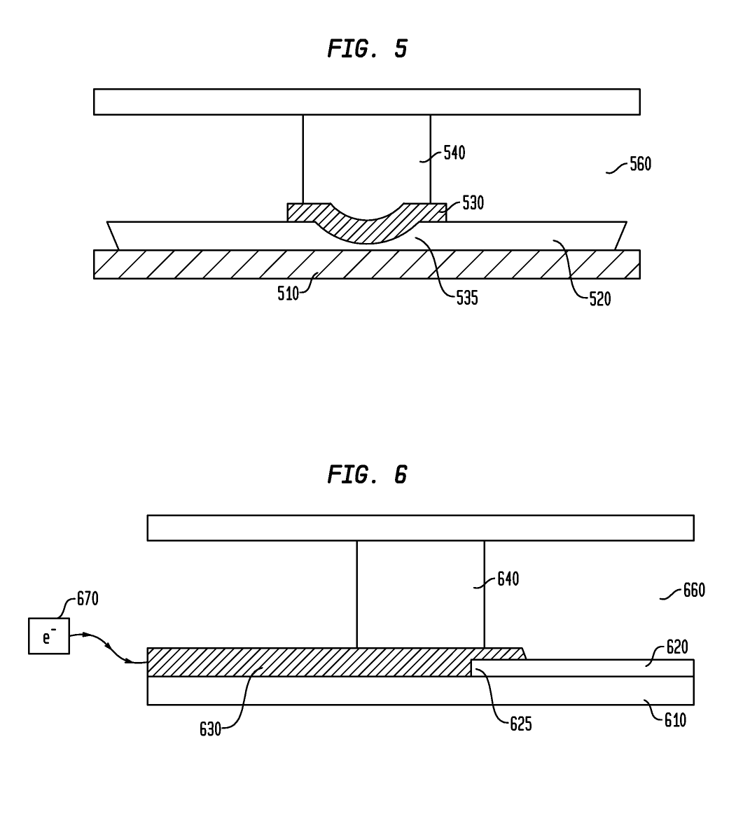

In other embodiments, a seal is applied over or covers at least a portion of a single, continuous bus bar. In some embodiments, a seal is positioned over and/or covers and/or penetrates the pores of at least a portion of the bus bar that is under a spacer (typically the portion that passes under the spacer). In these embodiments, it is believed that the conductive seal serves to conduct voltage and/or current while preventing the escape of inert gas from the interior space 560 through, for example, a porous bus bar. For example, FIG. 5 illustrates an EC device having a single continuous bus bar 520. A conductive seal 530 is positioned over at least the region of the bus bar 535 which contacts or is positioned under the spacer 540. In some embodiments, the thickness width of the continuous bus bar 520 is consistent. In other embodiments, the thickness or width of the bus bar at the contact point of the spacer 535 is less than the thickness of the bus bar at other regions or positions.

In yet other embodiments, a conductive seal is connected to a bus bar and an external voltage source. Referring now to FIG. 6, EC device 610 has a single bus bar 620 positioned within the interior space 660. In some embodiments, the bus bars terminate within about 0.1 cm to about 1.0 cm of the spacer 640. In some embodiments, the bus bar may extend partially under at least a portion of the seal. A conductive seal 630 is in contact with at least a portion of the bus bar and in communication with an electrical source 670. The conductive seal 630 extends from the termination point of the bus bar 625, continues under the spacer 640, and preferably continues to about the edge of the EC device. The conductive seal 630 serves to conduct voltage/current from the electrical source 670 while preventing the escape of inert gas from the interior space 660.

In some embodiments, the conductive seal is applied in-line with the bus bar material without overlap. In other embodiments, the conductive seal is applied in-line with the bus bar material and at least partially overlapping the bus bar in at least one dimension. The amount of overlap will depend, inter alia, on the properties of the conductive seal material and the bus bar material (for example, the resistivity of the conductive seal material and the ability of the conductive seal material to adhere to the bus bar material).

For example, referring again to FIGS. 4A, 4B, and 4C, the conductive seal may be applied in-line with the bus bar material and at least partially overlapping with least one of the internal or external bus bars 420 and 425. In yet other embodiments, the conductive seal is applied in-line with the bus bar material and overlaps with both the internal and external bus bars 420 and 425, respectively.

In embodiments where the conductive seal overlaps the bus bar(s), the overlap ranges from about 0.5 mm to about 3 mm. Where there is overlap between the conductive seal and the bus bar, it is preferred that the overlap occurs on all edges of the bus bar as depicted in FIG. 4c.

Conductive Seal

The conductive seal may be comprised of any conductive material known in the art. In general, the material used for the conductive seal (referred to herein as “conductive seal material”) should possess a combination of characteristics including: (a) sufficient adhesion to the substrate and/or bus bars; (b) compatibility with the substrate and/or bus bars; (c) workable characteristics (e.g. cure time, cure temperature, etc.); (d) suitable electrical conductivity; (e) suitable electrical resistivity; (f) suitable porosity; (g) resistance to corrosion; (h) ability to be applied consistently and uniformly; (i) good long term thermal stability; (j) resistance to mechanical stress; (k) low moisture absorption (or moisture resistance); and (l) acceptable coefficient of thermal expansion.

In some embodiments, the conductive seal material is able to acceptably adhere to the bus bars and substrate such that sufficient electrical conductivity can be maintained during the lifetime of the device, even after the device is subjected to stresses (e.g. thermal gradients, wind loading, sheer forces).

In some embodiments, the conductive seal material is selected such that the necessary curing temperature of the material would not cause damage (e.g. warping, deformation, peeling) to the substrate or EC device (including the thin films and bus bars comprising the EC device). In other embodiments, the conductive seal material is cured at a temperature below about 420° C. In yet other embodiments, the conductive seal material is cured at temperature below about 400° C. In yet other embodiments, the conductive seal material is cured at temperature below about 370° C. In yet other embodiments, the conductive seal material is selected to have a cure time and/or temperature that is the same as the cure time and/or temperature needed to cure the bus bar(s). In even further embodiments, the conductive seal material is selected to be cured at a temperature between about 150° C. and about 390° C.

In yet other embodiments, the conductive seal material is selected such that the electrical current and/or charge supplied to the EC device is about the same (or within about 25%) as if the electrical source were connected directly to a single component bus bar. In some embodiments, the electrical resistivity of the conductive seal material ranges between about 0.1 ohm/ft to about 0.6 ohm/ft. In other embodiments, the electrical resistivity of the conductive seal material ranges between about 0.2 ohm/ft to about 0.3 ohm/ft.

In some embodiments, the conductive seal material has a porosity less than that found in thick film material as known to those of ordinary skill in the art. In other embodiments, the conductive seal material is selected such that the resulting conductive seal prevents or mitigates the transfer of a gas across or through the seal.

In some embodiments, the conductive seal material is an adhesive, resin, or polymer impregnated with a suitable conductive metal (where the metal, for example, may be in the form of dispersed particles, nanoparticles, or in another form known to those of skill in the art.) In other embodiments, the conductive seal material is an intrinsically conductive polymer including, but not limited to, polythiophenes, poly(3-alkylthiophenes), polypyrroles, polyanilines, and linear conjugated B-systems including polymers comprising substituted and unsubstituted aromatic and heteroaromatic rings (e.g. 5 or 6 membered aromatic and heteroaromatic rings). In some embodiments, the linear conjugated B-system conductive polymer is a linearly conjugated B-systems of repeating monomer units of aniline, thiophene, pyrrole, and/or phenyl mercaptan that are ring-substituted with one or more (e.g. 1, 2, or 3) straight or branched alkyl, alkoxy, or alkoxyalkyl groups, wherein the alkyl, alkoxy, or alkoxyalkyl groups each contain from 1 up to about 10 carbon atoms, or preferably from 1 to 4 carbon atoms).

In some embodiments, the conductive seal material is a conductive epoxy or epoxide (collectively referred to herein as “epoxy” or “epoxies”). Specifically, the conductive epoxy may be a standard epoxy filled with an electrically conductive material, such as metal elements (for example gold and silver), metalloids, or other material such as carbon, which by filling the standard epoxy results in a conductive epoxy, or carbides of metal elements. The conductive adhesive may also include an electrically conductive organic (or polymeric) material or an electrically non-conductive organic (or polymeric) material filled with a conductive material.

Suitable conductive epoxies include, without limitation, commercially available silver epoxies, nickel epoxies, chromium epoxies, gold epoxies, tungsten epoxies, alloy epoxies and combinations thereof.

In some embodiments, the conductive epoxies are selected from Tra-Duct® 2902 silver epoxy (available from Tra-Con, Inc.) and Applied Technologies 5933 alloy (70/25/5 weight percent Ag/Au/Ni) epoxy (available from Applied Technologies). In other embodiments, the conductive epoxy is an EPDXIES 40-3905 (an electrically conductive epoxy adhesive and coating designed for applications requiring low temperature cures) or an EPDXIES 40-3900 (an electrically conductive epoxy resin filled with pure silver), both available from EPDXIES, Cranston, R.I. In another embodiment, the conductive epoxy is AGCL-823, a silver/silver chloride electrically conductive epoxy, available from Conductive Compounds, Hudson, N.J.

In another embodiment, the conductive seal material is an electrically conductive adhesive based on an acrylate resin filled with a silver plating graphite nanosheet (Zhang, Yi, “Electrically Conductive Adhesive Based on Acrylate Resin Filled With Silver Plating Graphite Nanosheet,” Synthetic Metals, Vol. 161, Issues 5-6, March 2011, Pages 516-522).

Non-Conductive Seal

In some embodiments, a non-conductive seal or insulator is used to prevent gas leak or shorts. Any known non-conductive material or insulator may be used for this purpose, including resins, adhesives, epoxies, or other polymers (e.g. polyisobutlyene).

Methods of Manufacturing

Another embodiment of the present invention is a method of making an EC device having a bus bar bridged by or connected to a conductive seal.

After deposition of the films of an EC device, a bus bar material is dispensed or applied onto the substrate or EC device surface, according to those procedures known in the art. In one embodiment, a bus bar comprised of silver particles and optionally lead containing frit material may be applied to the EC film stack with a frit direct dispense pump.

Typically, the bus bar is applied on the substrate up to about the edge of the spacer. In some embodiments, the internal and external bus bars are applied to within about 0.1 cm to about 1.0 cm from the edge of the spacer.

The conductive seal material can be applied by a variety of methods including but not limited to screen printing and dispensing. In some embodiments, the conductive seal material applied according to those same methods used to dispense the bus bar material.

An effective amount of a conductive seal material is applied to form a seal and a conduit for the transfer of voltage and/or current. An “effective amount” means, for example, that sufficient conductive conduit material is applied such that a stable conductive path is established between, for example, the exterior and interior bus bars 420 and 425, respectively, preferably to maintain a suitable voltage and/or current across the conductive path.

The amount of conductive seal material applied depends on the properties of the conductive material and the characteristics of the conductive seal once cured. In some embodiments, a conductive material is applied such that the resulting conductive seal has a thickness of between about 20 um to about 50 um.

In some embodiments, the bus bar is applied and allowed to cure, followed by application of the conductive seal. In other embodiments, the bus bar and conductive seal are applied at the same time or in succession (bus bar applied first then conductive seal or conductive seal applied first then bus bar), followed by contemporaneous curing of both the bus bar and conductive seal.

### Example 1

The substrate was masked such that the bus bar area of desired width was exposed and the edges were covered by the masking material. The bus bar ended about 0.5 cm from an interior side of the spacer and resumed about 0.5 cm after a corresponding exterior side of the spacer. A conductive epoxy was used to bridge this unmasked area. The conductive epoxy (a silver-based epoxy from Heraeus, namely CL20-10070) was applied manually to the substrate over the unmasked region. Excess material was removed using a razor blade held flush against the masking material and scraped across the substrate. The masking material was then removed. The epoxy material was then cured at a temperature between 400° C.-450° C. for about 2-8 minutes. The epoxy material had a thickness of about 30 um to about 40 um when applied, which resulted in a conductive seal having a thickness of about 35 um after curing. When tested, the bridged bus bar had a resistivity sufficient to conduct a sufficient voltage/current to operate the EC device.

### Example 2

Example 1 was repeated. The epoxy was applied, however, with a dispenser pump (onto the substrate surface in the desired area, unmasked area). The substrate was fired at about 400° C.-450° C. for about 2-8 minutes. When tested, the bridged bus bar had a resistivity sufficient to conduct a sufficient voltage/current to operate the EC device.

### Example 3

Example 1 was repeated. The epoxy was applied through a dispenser onto the substrate surface in the desired area (unmasked area). The substrate was subjected to thermal processing at temperatures ranging from about 150° C. to about 200° C. for about 5 to about 10 minutes and was later fired at about 380° C. to about 400° C. for about 1 to about 5 minutes. When tested, the bridged bus bar had a resistivity sufficient to conduct a sufficient voltage/current to operate the EC device.

Comparative Test Data

EC devices having a conductive seal running under the IGU spacer caused less inert gas to escape from the interior space as compared with EC devices having a single, continuous bus bar comprised solely of frit material.

Four IGUs were constructed. IGUs E1 and E2 each comprised an EC device, measuring about 8″×8″, having seven parallel bus bars. Each bus bar was intersected and contacted at two points by an IGU spacer (as such, each bus bar had interior and exterior bus bar portions). A conductive seal bridged each bus bar at each of these contact points, the conductive seal passing under the spacer. An interior space (about 7.25″×7.25″) of the IGU was filled with argon gas.

The conductive seal in IGUs E1 and E2 were comprised of a silver-based epoxy from Heraeus, namely C120-10070. The conductive seal material was applied according to the methods described herein. The conductive seal had a thickness of about 25 um after curing (about 400° C. for about 4 minutes).

IGUs C1 and C2 (controls) each comprised an EC device, measuring 8″×8″, having seven parallel bus bars. Each bus bar was intersected and contacted at two points by the IGU spacer. No conductive seal material was applied to IGU C1 or IGU C2. An interior space (about 7.25″×7.25″) of the IGU was filled with argon gas.

Seven bus bars were applied to each of the IGUs to accelerate, it is believed, the loss of argon from the IGU interior space. Each of the four IGUs were tested under about the same conditions, namely about room temperature (between about 62° F. to about 75° F.). The argon concentration was measured periodically over time using a Sparklike GasGlass measuring tool. The argon concentration was measured at three different locations of the IGU and the data was averaged to provide the recorded percentage of argon contained within the IGU interior space. The IGUs were measured once to twice per day. None of the IGUs were placed under load (voltage/current cycling). None of the IGUs were exposed to thermal cycling or any other external stresses.

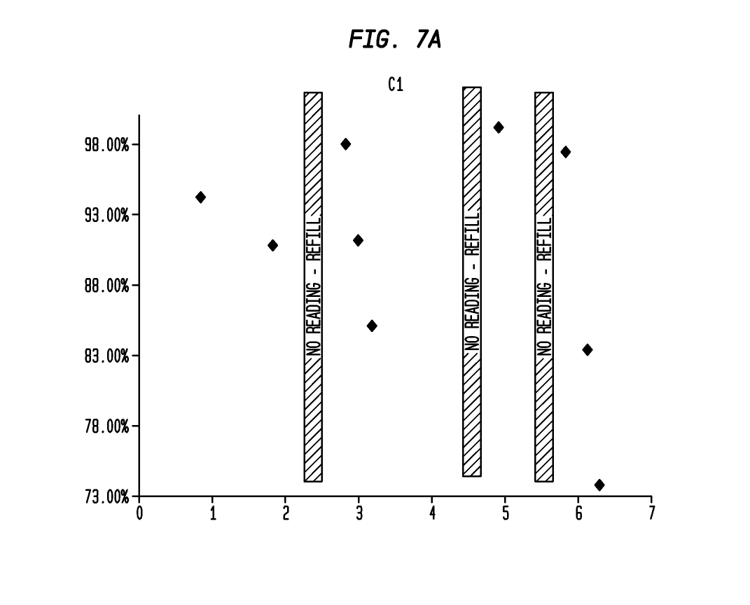

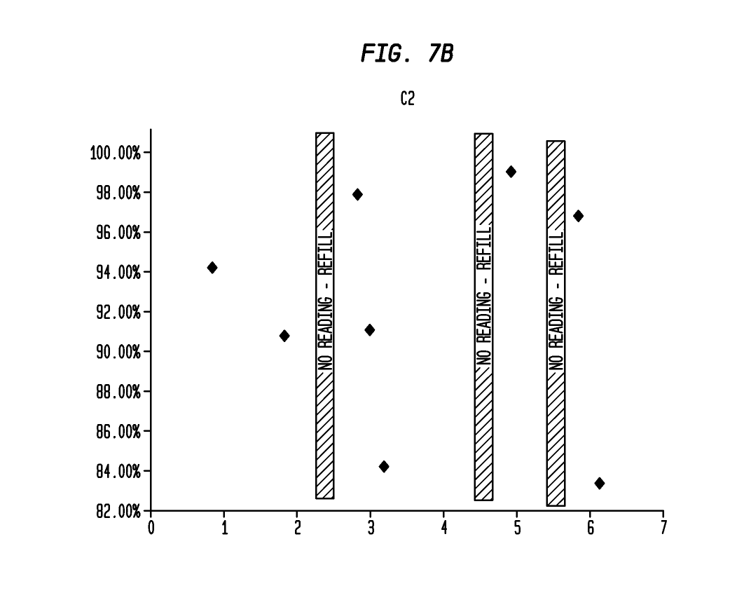

Compared to IGUs E1 and E2, the control IGUs C1 and C2 experienced a complete loss of argon over time (where a “complete loss” is defined as less than about 85% of the argon remaining in the interior IGU space), as demonstrated in FIGS. 7A and B. Even after the IGUs were refilled with argon, complete loss was again observed over time. It is believed that argon gas diffuses through a traditional bus bar.

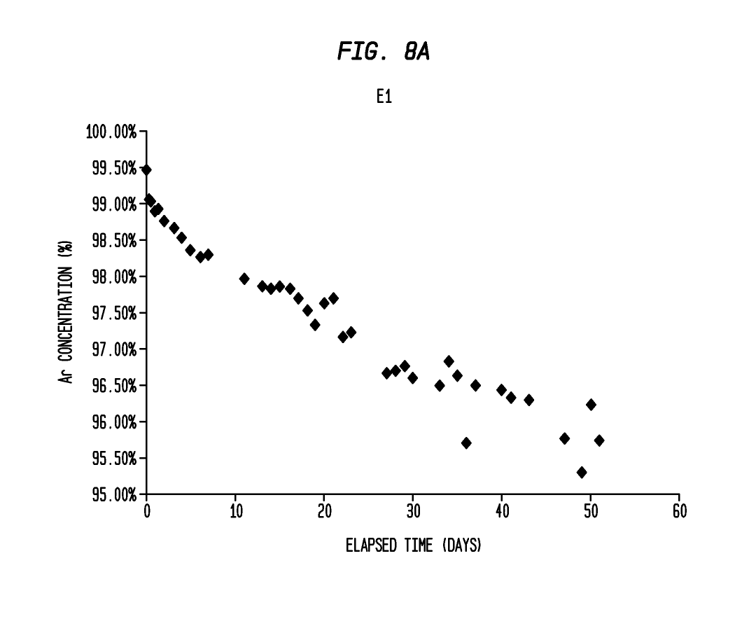

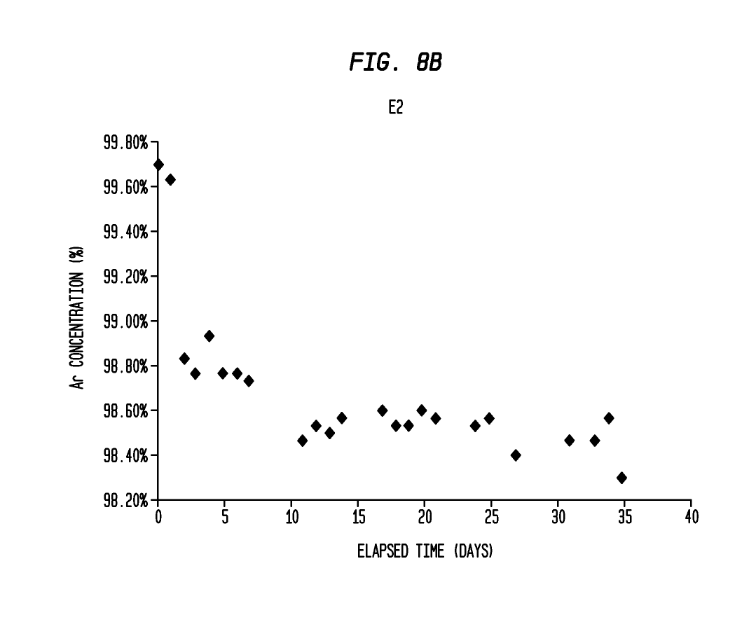

IGU E1 maintained an argon concentration of greater than about 96% after about 35 days, and greater than about 95% after about 50 days, as demonstrated in FIG. 8A. Similarly, IGU E2 maintained an argon concentration of greater than about 98% even after about 35 days as demonstrated in FIG. 8B. Accordingly, without wishing to be bound by any particular theory, it is believed that the use of a silver-based epoxy material, applied as a conductive seal as described herein, effectively reduced or mitigated the loss of argon from the interior IGU space as compared to control IGUs.

### Example 4

The pores were filled in the uninterrupted bus bar that traverses from the interior of the IGU to the exterior outside of the spacer. The approach was to fill the pores and interstitial spaces in the section of the bus bar that is under the spacer with an epoxy, e.g., Product 16028, Epoxy bond 110 from Ted Pella, Inc.

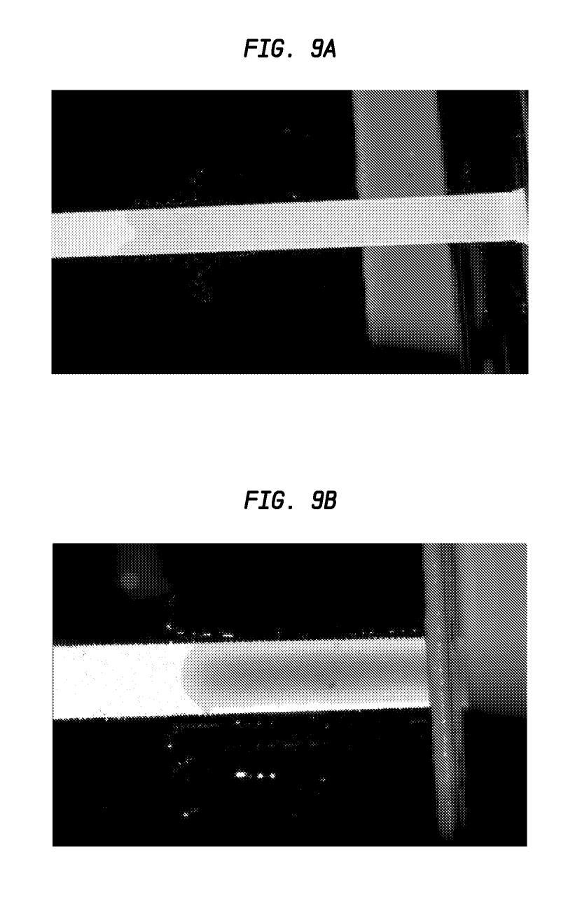

The top view, FIG. 9A, shows the epoxy on top of the bus bar that is extending under the spacer to the right. The bottom view through the substrate glass, FIG. 9B, shows the bus bar goes completely under the spacer and that the epoxy has completely penetrated through the porous bus bar.

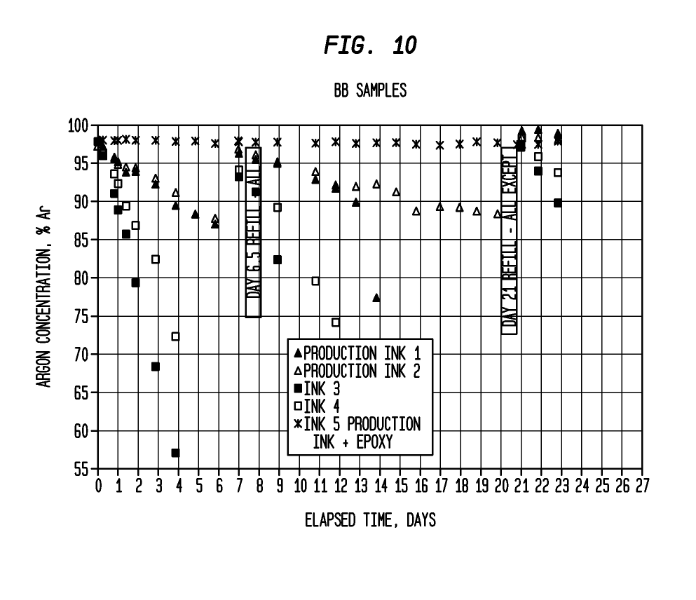

IGUs were prepared, each with 22 bus bars that were printed to traverse the seal area under the spacer (see FIG. 10). The objective was to maximize argon leakage for a test duration (23 days). We compared Production Ink bus bars impregnated with epoxy (ink 5) to four other Ag inks without the epoxy filler. All IGUs were initially filled with Ar, and the Ar concentration measured for 6 consecutive days. Then all four standard IGUs were refilled with Ar on day 7 and the Ar concentration measurements repeated. The epoxy filled bus bar IGU was not refilled over the duration of the testing. The Ar was measurably depleted in all but the IGUs with ink 5 (Production Ink+Epoxy).

### Example 5

We utilized a unique low firing temperature (about less than 430° C.) silver bus bar that sinters more completely, which was believed to restrict argon gas flow through the bus bar. The improved bus bar must, of course, retain all the desirable properties such as adhesion, conductivity, solderabiity, ability to be precisely dispensed or screened, etc. An increased density of the fired silver ink can be achieved by modifying the size distribution of Ag particles in the as received, unfired thick film paste. The size distribution of particles and flakes can range from about 1 micron to about 10 microns or greater, and the paste may even contain nano-silver particles in the about 50-200 nanometer size range. The size distribution was carefully controlled so that the smaller particles could fit into and fill the interstices (voids) between the larger Ag particles. As a result the particles could sinter together more completely yielding a less porous fired bus bar. Other factors that affect the porosity of the bus bar are glass frit particle size and composition as well as the chemistry of binders, surfactants, rheology modifiers, etc.

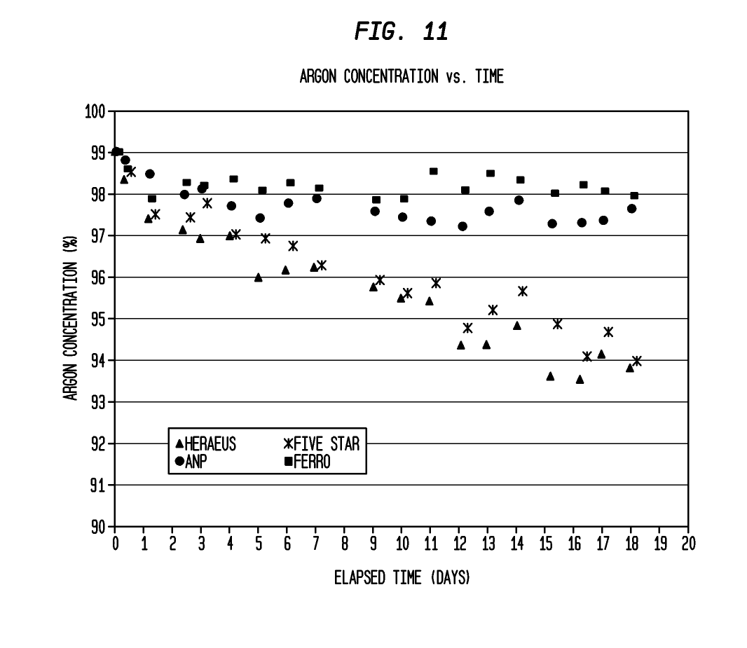

As shown in FIG. 11, low temperature inks formulated to reduce porosity resulted in significantly higher argon concentrations in the IGU versus standard low temperature inks.

### Example 6

Completely coat the bus bar segment external to the spacer with a low permeability (to argon) polymer. We have shown that coating low-firing-temperature thick film silver bus bars with a butyl hot melt polymer such as ADCO 3070-HS significantly reduced the release of argon that diffused through the porous bus bar. It was necessary to completely coat all segments of the bus bar (including the solder joint) with the butyl material.

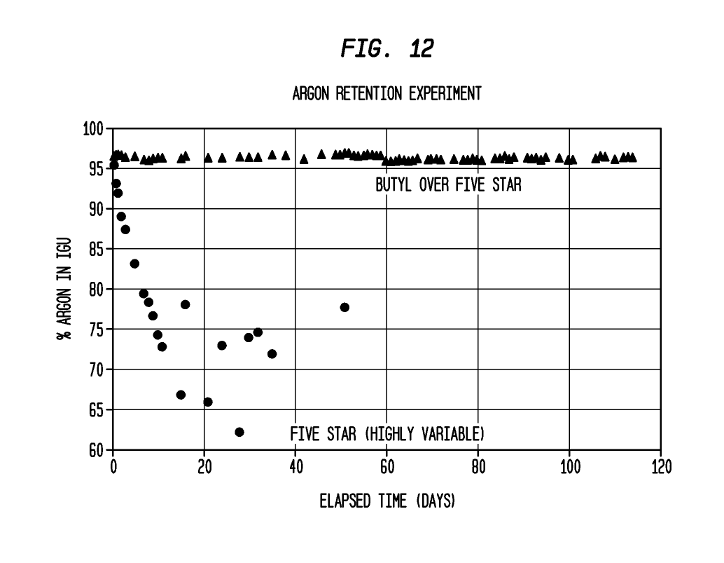

As shown in FIG. 12, 22 bus bar IGUs in which the external portion of the bus bar was coated with butyl polymer, completely retained the argon out to nearly 120 days. By comparison standard low temperature bus bars allowed rapid Ar diffusion from the IGU.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system comprising an electrochromic device having at least one bus bar and a conductive seal in communication with said at least one bus bar, wherein said conductive seal is less porous than said bus bar and has an electrical resistance between about 0.1 ohm/ft to about 0.6 ohm/ft.

2. The system of claim 1, wherein said conductive seal has a cure temperature of less than about 420° C.

3. The system of claim 2, wherein said conductive seal and said bus bar are cured contemporaneously.

4. The system of claim 1, wherein said conductive seal is comprised of a conductive epoxy selected from the group consisting of silver epoxies, nickel epoxies, chromium epoxies, gold epoxies, tungsten epoxies, alloy epoxies, and mixtures thereof.

5. The system of claim 1, wherein said conductive seal comprises a silver epoxy.

6. The system of claim 1, wherein said conductive seal is comprised of an intrinsically conductive polymer.

7. The system of claim 1, wherein said conductive seal mitigates the loss of a gas through said bus bar.

8. The system of claim 7, wherein said conductive seal retains at least 96% of said gas over at least about 35 days.

9. The system of claim 1, wherein said conductive seal at least partially overlaps said bus bar in at least one dimension.

10. The system of claim 1, wherein said conductive seal has a thickness ranging from about 20 μm to about 50 μm.

11. An insulated glass unit comprising an electrochromic device having at least two bus bars and a glass panel, wherein said electrochromic device and said glass panel are arranged substantially parallel to each other and are connected by a spacer to form an insulated space, and wherein a seal is sandwiched between said spacer and said electrochromic device and in communication with at least a portion of said at least two bus bars.

12. The insulated glass unit of claim 11, wherein said seal is a non-conductive material.

13. The insulated glass unit of claim 12, wherein said non-conductive seal is an epoxy, wherein said epoxy is less porous than said at least two bus bars.

14. The insulated glass unit of claim 11, wherein said seal is a conductive seal.

15. The insulated glass unit of claim 11, wherein at least one of said at least two bus bars are continuous.

16. The insulated glass unit of claim 15, wherein said conductive seal covers said continuous bus bar.

17. The insulated glass unit of claim 14, wherein at least one of said at least two bus bars are segmented.

18. The insulated glass unit of claim 17, wherein said segmented bus bar comprises an interior portion and an exterior portion.

19. The insulated glass unit of claim 18, wherein said conductive seal is in communication with at least a portion of each of said interior and exterior bus bar portions.

20. The insulated glass unit of claim 14, wherein said conductive seal is in communication with at least one of said at least two bus bars and an electrical voltage source.

21. The insulated glass unit of claim 11, wherein said conductive seal is comprised of a silver epoxy.

22. The insulated glass unit of claim 11, wherein an insulator is positioned between said spacer and said seal.

23. An insulated glass unit comprising an electrochromic device having at least two bus bars on a top surface of said electrochromic device and a glass panel, wherein said electrochromic device top surface and said glass panel are arranged substantially parallel to each other and are connected by a spacer to form an insulated space, wherein each of said bus bars have interior and exterior bus bar portions, said interior bus bar portions are positioned within said insulated space and said exterior bus bar portions are positioned outside said insulated space, and wherein a conductive seal is in communication with said interior and exterior bus bar portions.

24. The insulated glass unit of claim 23, wherein said conductive seal is positioned between said spacer and said electrochromic device top surface.

25. The insulated glass unit of claim 23, wherein said conductive seal bridges said interior and exterior bus bar portions and provides electrical communication between said interior and exterior bus bar portions.

26. The insulated glass unit of claim 24, wherein said conductive seal is in-line with said interior and exterior bus bar portions.

27. The insulated glass unit of claim 23, wherein said conductive seal at least partially overlaps with at least one of said interior or exterior bus bar portions.

28. The insulated glass unit of claim 23, wherein said conductive seal is less porous than said at least two bus bars and has an electrical resistance of between about 0.1 ohm/ft to about 0.6 ohm/ft.

29. The insulated glass unit of claim 23, wherein said conductive seal is selected from the group consisting of an adhesive impregnated with a suitable conductive metal, a resin impregnated with a suitable conductive metal, a polymer impregnated with a suitable conductive metal, and an intrinsically conductive polymer.

30. The insulated glass unit of claim 23, wherein said conductive seal is a conductive epoxy.

31. The insulated glass unit of claim 30, wherein said conductive epoxy is selected from the group consisting of silver epoxies, nickel epoxies, chromium epoxies, gold epoxies, tungsten epoxies, alloy epoxies, and mixtures thereof.

32. The insulated glass unit of claim 31, wherein said conductive seal comprises a silver epoxy.

33. An insulated glass unit comprising an electrochromic device having at least two bus bars on a top surface of said electrochromic device and a glass panel, wherein said electrochromic device top surface and said glass panel are arranged substantially parallel to each other and are connected by a spacer to form an insulated space, wherein each of said bus bars are continuous, whereby at least a portion of said at least two bus bars are positioned between said electrochromic device top surface and said spacer to form bus bar contact points, and wherein a conductive seal covers at least a portion of said bus bar contact points.

34. The insulated glass unit of claim 33, wherein said conductive seal is less porous than said at least two bus bars and has an electrical resistance of between about 0.1 ohm/ft to about 0.6 ohm/ft.

35. The insulated glass unit of claim 33, wherein said conductive seal is selected from the group consisting of an adhesive impregnated with a suitable conductive metal, a resin impregnated with a suitable conductive metal, a polymer impregnated with a suitable conductive metal, and an intrinsically conductive polymer.

36. The insulated glass unit of claim 33, wherein said conductive seal is a conductive epoxy.

37. The insulated glass unit of claim 36, wherein said conductive epoxy is selected from the group consisting of silver epoxies, nickel epoxies, chromium epoxies, gold epoxies, tungsten epoxies, alloy epoxies, and mixtures thereof.

38. The insulated glass unit of claim 33, wherein said conductive seal comprises a silver epoxy.

39. An insulated glass unit comprising an electrochromic device having at least two bus bars on a top surface of said electrochromic device and a glass panel, wherein said electrochromic device top surface and said glass panel are arranged substantially parallel to each other and are connected by a spacer to form an insulated space, wherein each of said bus bars are located substantially within said insulated space, and wherein a conductive seal is in communication with at least a portion of said bus bars and an external voltage source.

40. The insulated glass unit of claim 39, wherein said conductive seal is less porous than said at least two bus bars and has an electrical resistivity of between about 0.1 ohm/ft to about 0.6 ohm/ft.

41. The insulated glass unit of claim 39, wherein said conductive seal is selected from the group consisting of an adhesive impregnated with a suitable conductive metal, a resin impregnated with a suitable conductive metal, a polymer impregnated with a suitable conductive metal, and an intrinsically conductive polymer.

42. The insulated glass unit of claim 39, wherein said conductive seal is a conductive epoxy.

43. The insulated glass unit of claim 42, wherein said conductive epoxy is selected from the group consisting of silver epoxies, nickel epoxies, chromium epoxies, gold epoxies, tungsten epoxies, alloy epoxies, and mixtures thereof.

44. The insulated glass unit of claim 39, wherein said conductive seal comprises a silver epoxy.

45. A method of mitigating a loss of a gas from an insulated space in an insulated glass unit comprising covering a portion of a bus bar that passes under a spacer in said insulated glass unit with a seal.

46. The method of claim 45, wherein said seal is a conductive seal.

47. The method of claim 46, wherein said conductive seal is a conductive epoxy.

48. The method of claim 47, wherein said conductive epoxy is selected from the group consisting of silver epoxies, nickel epoxies, chromium epoxies, gold epoxies, tungsten epoxies, alloy epoxies, and mixtures thereof.

49. The method of claim 45, wherein said conductive seal comprises a silver epoxy.
